(19) United States
(12) Patent Application Publication
(10) Pub. No.: US 2013/0204680 A1
(43) Pub. Date: Aug. 8, 2013

(54) ADVERTISEMENT SYSTEM, METHOD OF CONTROLLING ADVERTISEMENT SYSTEM, ADVERTISEMENT CONTROL DEVICE, PROGRAM, AND INFORMATION RECORDING MEDIUM

(71) Applicant: Suguru Suzuki, Shinagawa-ku (JP)

(72) Inventor: Suguru Suzuki, Shinagawa-ku (JP)

(73) Assignee: Rakuten, Inc., Shinagawa-ku, Tokyo (JP)

(21) Appl. No.: 13/878,802

(22) PCT Filed: Sep. 27, 2011
(86) PCT No.: PCT/JP2011/072096

§ 371 Date: Apr. 11, 2013

(30) Foreign Application Priority Data
Oct. 15, 2010 (JP) 2010-233084

(51) Int. Cl. G06Q 30/02

(52) U.S. Cl. CPC G06Q 30/0241
USPC 705/14.4

(57) ABSTRACT

To provide an advertisement system for enabling an efficient advertisement for an article or a service. An advertisement system (1) provides an advertisement for an article or a service during a sales period of the article or the service. A reference correspondence storage section (51) stores information on a reference correspondence between a time point in the sales period and a sales state of the article or the service. A sales state acquisition section (52) acquires information on the sales state of the article or the service at a certain time point in the sales period. A determination section (53) determines whether or not the certain time point and the sales state of the article or the service at the certain time point have the reference correspondence. An advertisement provision section (55) provides the advertisement based on a determination result by the determination section (53).

### TECHNICAL FIELD

The present invention relates to an advertisement system, a method of controlling an advertisement system, an advertisement control device, a program, and an information storage medium.

### BACKGROUND ART

An advertisement system for providing consumers with advertisements of articles (goods) or services via communication networks is known (for example, refer to Patent Literature 1).

### CITATION LIST

### Patent Literature

[Patent Literature 1]: JP 2001-283090 A

### SUMMARY OF INVENTION

### Technical Problem

An advertiser wants the advertisement to be carried out efficiently. For example, the advertiser wants the advertisement to be carried out if the article does not sell well, and wants the advertisement to be restrained if the article sells well. However, it is sometimes difficult to predict the sales of an article, and in some cases, an advertisement is not carried out efficiently in practice. For example, a situation where an advertisement is carried out for an article which sells well, and an advertisement is not carried out for an article which does not sell well arises in some cases.

The present invention has been made in view of the above-mentioned problem, and has an object to provide an advertisement system, a method of controlling an advertisement system, an advertisement control device, a program, and an information storage medium for enabling an efficient advertisement for an article or a service.

### Solution to Problem

In order to solve the above-mentioned problem, an advertisement system according to the present invention is an advertisement system for providing an advertisement for an article or a service during a sales period of the article or the service, the advertisement system including: reference correspondence storage means for storing information on a reference correspondence between a time point in the sales period and a sales state of the article or the service; sales state acquisition means for acquiring information on the sales state of the article or the service at a certain time point in the sales period; determination means for determining whether or not the certain time point and the sales state of the article or the service at the certain time point have the reference correspondence; and advertisement provision means for providing the advertisement based on a determination result by the determination means.

A method of controlling an advertisement system according to the present invention is a method of controlling an advertisement system for providing an advertisement for an article or a service during a sales period of the article or the service, the method including: a step of acquiring a reference correspondence, based on information on the reference correspondence between a time point in the sales period and a sales state of the article or the service, which is stored in reference correspondence storage means for storing the information; a sales state acquisition step of acquiring information on the sales state of the article or the service at a certain time point in the sales period; a determination step of determining whether or not the certain time point and the sales state of the article or the service at the certain time point have the reference correspondence; and an advertisement control step of controlling provision of the advertisement based on a determination result in the determination step.

An advertisement control device according to the present invention is an advertisement control device for controlling provision of an advertisement for an article or a service during a sales period of the article or the service, the advertisement control device including: means for acquiring a reference correspondence, based on information on the reference correspondence between a time point in the sales period and a sales state of the article or the service, which is stored in reference correspondence storage means for storing the information; sales state acquisition means for acquiring information on the sales state of the article or the service at a certain time point in the sales period; determination means for determining whether or not the certain time point and the sales state of the article or the service at the certain time point have the reference correspondence; and advertisement control means for controlling the provision of the advertisement based on a determination result by the determination means.

A program according to the present invention is a program for causing a computer to function as an advertisement control device for controlling provision of an advertisement for an article or a service during a sales period of the article or the service, the program further causing the computer to function as: means for acquiring a reference correspondence, based on information on the reference correspondence between a time point in the sales period and a sales state of the article or the service, which is stored in reference correspondence storage means for storing the information; sales state acquisition means for acquiring information on the sales state of the article or the service at a certain time point in the sales period; determination means for determining whether or not the certain time point and the sales state of the article or the service at the certain time point have the reference correspondence; and advertisement control means for controlling the provision of the advertisement based on a determination result by the determination means.

A computer-readable information storage medium according to the present invention is a computer-readable information storage medium having the above-mentioned program recorded thereon.

Further, according to an aspect of the present invention, the advertisement system may further include means for determining whether or not to provide the advertisement, based on the determination result by the determination means, and the advertisement provision means may provide the advertisement in a case where it is determined that the advertisement is provided.

Further, according to an aspect of the present invention, the sales state of the article or the service may be at least one of a number of purchases of the article or the service and a remaining number of the articles or the services which are salable, and the sales state acquisition means may acquire information on at least one of the number of purchases of the article or the service up to the certain time point and the remaining number of the articles or the services which are salable at the certain time point.

Further, according to an aspect of the present invention, the sales state acquisition means may acquire, at a predetermined time point, the information on the sales state of the article or the service at the predetermined time point, and the determination means may determine whether or not the predetermined time point and the sales state of the article or the service at the predetermined time point have the reference correspondence.

Further, according to an aspect of the present invention, the article or the service may be sold by a sales method of decreasing a unit price of the article or the service sold during the sales period depending on an increase in a number of sales of the article or the service during the sales period, and the advertisement system may further include means for restricting the provision of the advertisement in a case where the unit price of the article or the service decreases down to a predetermined minimum unit price.

Further, according to an aspect of the present invention, the article or the service may be sold by a sales method of decreasing a unit price of the article or the service sold during the sales period depending on an increase in a number of sales of the article or the service during the sales period. The advertisement provision means may include advertisement content setting means for setting a content of the advertisement, based on the sales state of the article or the service. The advertisement content setting means may include, in the content of the advertisement, at least one of: a content relating to a deficit number of sales of the article or the service for decreasing the unit price of the article or the service; a content relating to a degree of decrease in unit price of the article or the service; and a content relating to an end time point of the sales period.

Further, according to an aspect of the present invention, the advertisement provision means may provide the advertisement by posting a comment in a communication service for receiving a post of the comment and making public the comment.

Further, according to an aspect of the present invention, the advertisement provision means may include means for changing a method of providing the advertisement, based on the determination result by the determination means.

Further, according to an aspect of the present invention, the advertisement system may further include: means for storing information on a priority of the advertisement; and means for setting the priority of the advertisement based on the determination result by the determination means. The advertisement provision means may provide the advertisement based on the priority of the advertisement.

Further, according to an aspect of the present invention, the reference correspondence storage means may store advertisement control information on control of the provision of the advertisement associated with the reference correspondence, and in a case where the determination result as to whether or not the certain time point and the sales state of the article or the service at the certain time point have the reference correspondence is a predetermined result, the advertisement provision means may provide the advertisement based on the advertisement control information associated with the reference correspondence.

### Advantageous Effects of the Invention

According to the present invention, an efficient advertisement for the article or the service is enabled.

### BRIEF DESCRIPTION OF DRAWINGS

FIG. 1 A diagram illustrating an overall configuration of an electronic commerce system according to an embodiment of the present invention.

FIG. 2 A diagram illustrating a hardware configuration of a server.

FIG. 3 A diagram illustrating an example of a top screen.

FIG. 4 A diagram illustrating an example of an article screen.

FIG. 5 A diagram illustrating an example of an advertisement.

FIG. 6 A diagram illustrating an overview of advertisement control.

FIG. 7 A functional block diagram of the electronic commerce system according to the embodiment.

FIG. 8 A diagram illustrating an example of a user table.

FIG. 9 A diagram illustrating an example of a purchase history table.

FIG. 10 A diagram illustrating an example of an article table .

FIG. 11 A diagram illustrating an example of a joint purchase table.

FIG. 12 A diagram illustrating an example of a joint purchase price table.

FIG. 13 A diagram illustrating an example of a joint purchase state table.

FIG. 14 A diagram illustrating an example of an advertisement table.

FIG. 15 A diagram illustrating an example of a reference correspondence table.

FIG. 16 A flowchart illustrating an example of processing carried out by the electronic commerce system.

FIG. 17 A flowchart illustrating an example of the processing carried out by the electronic commerce system.

FIG. 18 A flowchart illustrating an example of the processing carried out by the electronic commerce system.

FIG. 19 A diagram illustrating another example of the advertisement control.

FIG. 20 A diagram illustrating another example of the reference correspondence table.

### DESCRIPTION OF EMBODIMENTS

A detailed description is now given of an embodiment of the present invention referring to the drawings. On this occasion, a description is given of a case where the present invention is applied to an electronic commerce system. Specifically, a description is given of an example of a case where an advertisement system according to the embodiment of the present invention is realized in an electronic commerce system realizing a virtual shopping mall where a plurality of shops is opened.

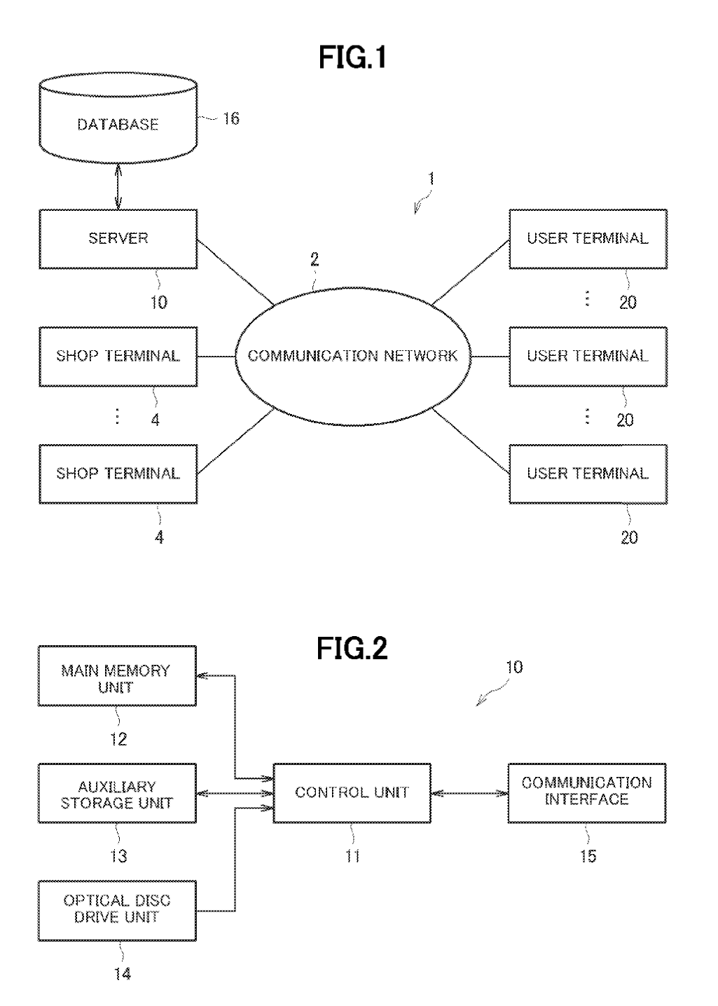

FIG. 1 illustrates an overall configuration of the electronic commerce system according to the embodiment of the present invention. As illustrated in FIG. 1, an electronic commerce system 1 according to this embodiment includes a server 10 (advertisement control device), a database 16, a plurality of user terminals 20, and a plurality of shop terminals 4. The server 10, the plurality of user terminals 20, and the plurality of shop terminals 4 are connected to a communication network 2 including, for example, the Internet and the like. Between the server 10 and the user terminals 20, mutual data communication can be established. Between the server 10 and the shop terminals 4, mutual data communication can also be established.

The server 10 is a virtual shopping mall server functioning as, for example, a portal for the virtual shopping mall. The server 10 carries out processing based on a processing request received from the user terminal 20 or the shop terminal 4. FIG. 2 illustrates a hardware configuration of the server 10. As illustrated in FIG. 2, the server 10 includes a control unit 11, a main memory unit 12, an auxiliary storage unit 13, an optical disc drive unit 14, and a communication interface 15.

The control unit 11 includes, for example, a central processing unit (CPU), and carries out various types of processing in accordance with programs. The main memory unit 12 includes, for example, a random access memory (RAM). The main memory unit 12 stores programs and data read out from the auxiliary storage unit 13 or an optical disc (information storage medium). Moreover, the main storage unit 12 is also used as a work memory for storing data required in the course of processing. The auxiliary storage unit 13 includes, for example, a hard disk device.

The optical disc drive unit 14 reads programs and data stored in an optical disc. The communication interface 15 is an interface for connecting the server 10 to the communication network 2. Note that, programs and data are provided via an optical disc to the server 10. Moreover, programs and data may be provided to the server 10 via the communication network 2 from a remote location.

The server 10 can make access to the database 16. The database 16 stores, for example, information on users who use the virtual shopping mall, information on articles which the virtual shopping mall deals in, information on transactions carried out on the virtual shopping mall, and the like. Note that, the database 16 may be constructed in the server 10, or may be constructed in a server different from the server 10.

The shop terminal 4 is an information processing device provided on a shop opened on the virtual shopping mall. The shop terminal 4 is, for example, a personal computer. The shop terminal 4 is used to register information on articles sold on the virtual shopping mall and the like via the server 10 to the database 16. For example, a dedicated screen provided by the server 10 is displayed on the shop terminal 4. An administrator on the shop side can input, on the dedicated screen, basic information on articles, information on a method of selling articles, and the like.

The user terminal 20 is an information processing device operated by a user. The user terminal 20 is, for example, a personal computer, a cellular phone, or a personal digital assistant (PDA). The user terminal 20 is used to purchase articles in the virtual shopping mall.

In the case of this embodiment, for example, a hypertext transfer protocol (HTTP) daemon is activated on the server 10. Moreover, a browser is activated on the user terminal 20, and a processing request (HTTP request) is transmitted from the user terminal 20 to the server 10 via the browser. Moreover, a processing result (HTTP response) corresponding to the processing request is transmitted from the server 10 to the user terminal 20. For example, page data described in a Web page description language is transmitted to the user terminal 20. Then, based on the page data, a screen based on the processing result is displayed on a display unit of the user terminal 20.

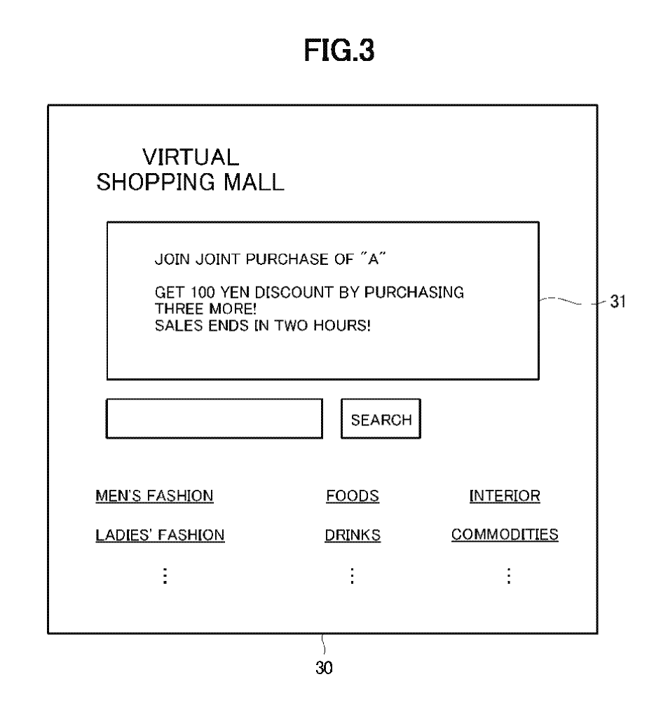

The user who uses the virtual shopping mall uses the user terminal 20 to make access to the server 10. In this case, a top screen (top page) of the virtual shopping mall is displayed on the display unit of the user terminal 20. FIG. 3 illustrates an example of the top screen. On the top screen 30, the user can search for articles, or can select a category of articles. Note that, an advertisement 31 is displayed in the top screen 30 illustrated in FIG. 3. A description is given later of the advertisement 31.

When the user specifies search conditions for articles, the search for articles is carried out on the server 10, and an article list screen (not shown) showing a list of articles satisfying the search conditions is displayed on the display unit of the user terminal 20. Moreover, when the user selects a category of articles, a list of articles belonging to the category is acquired on the server 10, and an article list screen (not shown) showing the list is displayed on the display unit of the user terminal 20.

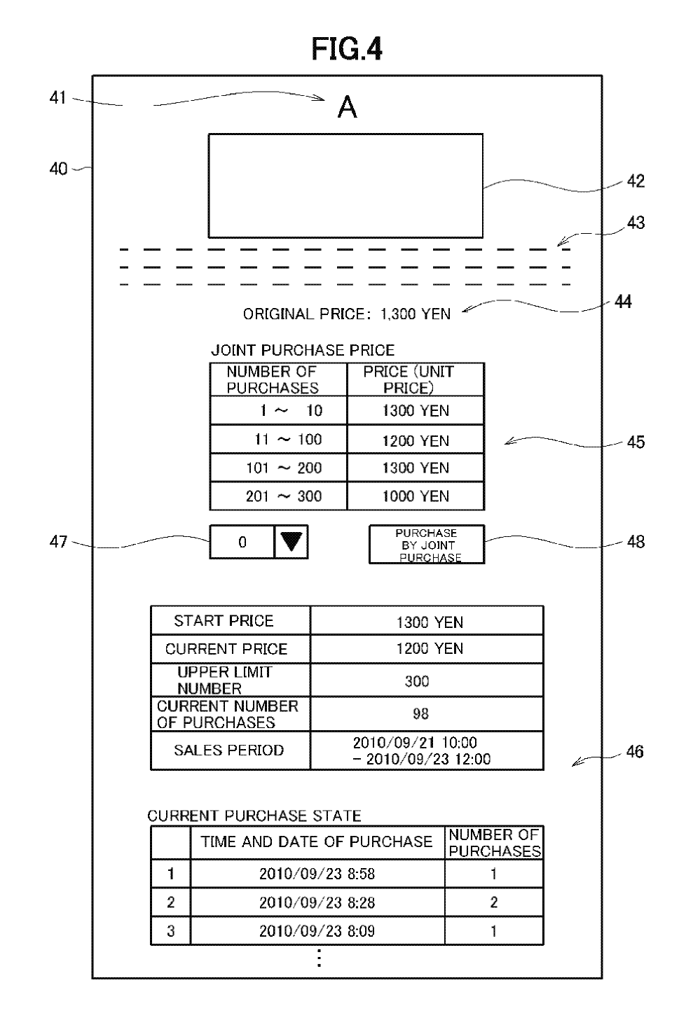

Moreover, when the user selects any one of articles on the article list screen, information on the article is acquired on the server 10, and an article screen for purchasing the article is displayed on the user terminal 20. FIG. 4 illustrates an example of the article screen. Note that, the article screen 40 illustrated in FIG. 4 is an article screen for an article subject to a joint purchase (a group purchase).

A description is now given of “joint purchase”. In the electronic commerce system 1, a shop can employ a sales method of a joint purchase type, thereby selling articles. For example, when an article “A” is sold by means of the sales method of the joint purchase type, a sales period of the article “A” is determined, and persons who want to purchase the article “A” are invited during the sales period. Then, a unit price of the article “A” purchased during the sales period is determined depending on a total number of purchases of the article “A” during the sales period. As the number of purchases of the article “A” increases (in other words, as the number of persons who purchase the article “A” increases), the unit price of the article “A” decreases. The shop can determine whether or not to employ the sales method of the joint purchase type for each of articles. Note that, in response to a request from users, an article may be sold by means of the sales method of the joint purchase type.

A name of article 41, an image 42, a description 43, and an original price 44 are displayed in the article screen 40 illustrated in FIG. 4. Moreover, Pieces of information 45 and 46 specific to an article subject to the joint purchase are displayed the article screen 40. In other words, prices for the joint purchase are displayed. Moreover, a sales period, a price at start, a current price, a number of purchases up to now, and an upper limit number of articles which a shop can sell are also displayed. Further, a current state of purchase is also displayed.

On the article screen 40 illustrated in FIG. 4, the number of purchases of the article reaches 98, and the unit price of the article is 1,200 yen, which is cheaper by 100 yen than an original price (1,300 yen). When the sales period ends in this state, the article is sold at the unit price of 1,200 yen to respective purchasers. Moreover, when three more articles are purchased after this state, and the number of purchases of the article reaches 101, the unit price of the article decreases to 1,100 yen, which is cheaper by 200 yen than the original price.

A user who purchases the article selects a quantity in a quantity selection menu 47, and clicks a joint purchase button 48. When the joint purchase button 48 is clicked, a purchase screen (not shown) for carrying out a purchase procedure is displayed on the display unit of the user terminal 20. The user carries out the purchase procedure on the purchase screen.

The electronic commerce system 1 has an advertisement function in addition to the basic electronic commerce function described above. A description is now given of the advertisement function.

In the electronic commerce system 1, a shop can determine whether or not each of articles is advertised. Then, an advertisement for an article which is determined to be advertised is displayed on various screens. For example, an advertisement is displayed on the top screen 30 or the article list screen.

As described above, the advertisement 31 is displayed in the top screen 30 illustrated in FIG. 3. The advertisement 31 of FIG. 3 is an advertisement for an article subject to the joint purchase, and has a content of promoting the joint purchase of the article. Specifically, in addition to an article name, the following pieces of information on the purchase state of the article are described on the advertisement 31.

(1) A deficit number of purchases for decreasing a unit price of the article from a current unit price
(2) A reduction amount (different amount from the original unit price) if the unit price of the article decreases from the current unit price
(3) A remaining time until a sales period ends

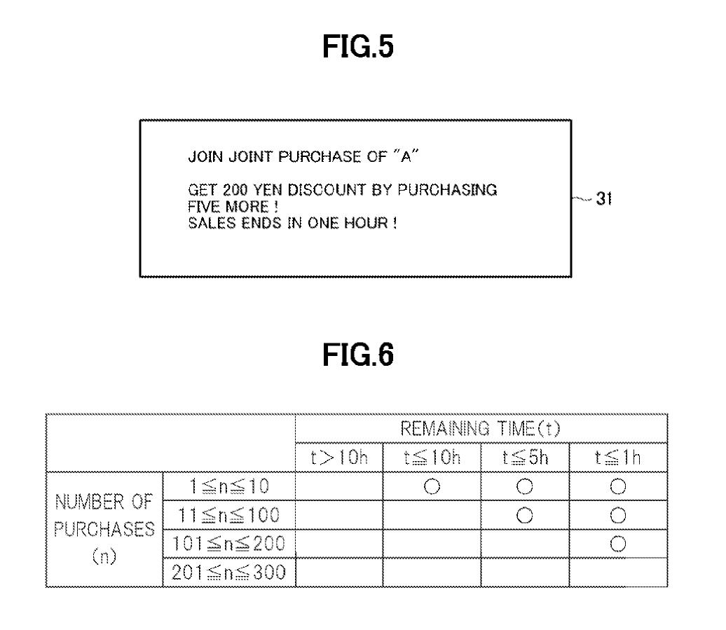

The content of the advertisement 31 includes information on the purchase state of the article, and hence the content of the advertisement 31 changes depending on the purchase state of the article. For example, when the remaining time until the sales period ends is one hour, and five more purchases of the article decreases a unit price from the original price by 200 yen, the content of the article 31 changes to a content illustrated in FIG. 5.

The advertisement function of the electronic commerce system 1 is configured to efficiently carry out an advertisement considering the purchase state of an article. For example, when an article sells well, an advertisement is restrained, and when an article does not sell well, an advertisement is carried out.

FIG. 6 is a diagram illustrating an example of advertisement control for an article subject to the joint purchase. Note that, FIG. 6 illustrates an example of the advertisement control for the article “A” displayed on the article screen 40 illustrated in FIG. 4.

In FIG. 6, “REMAINING TIME” means a remaining time until the sales period for the article “A” ends. For example, “t≦10 h” represents that the remaining time until the sales period ends is equal to or less than ten hours. “NUMBER OF PURCHASES” means the number of the articles “A” which has been purchased after the sales period started until a subject time point. Moreover, a circle sign represents that an advertisement is carried out, and a blank field represents that an advertisement is not carried out.

The advertisement control illustrated in FIG. 6 is configured so as to carryout an advertisement considering a state of the joint purchase. In other words, considering both the remaining time until the sales period ends, and the number of purchases until a subject time point, an advertisement is carried out.

In other words, if the remaining time is longer than ten hours, regardless of the number of purchases of the article “A” until the subject time point, the article “A” is not advertised. Moreover, if the remaining time is equal to or less than ten hours, and the number of purchases of the article “A” until the subject time point is equal to or less than ten, it is considered that the article “A” does not sell well, and the article “A” is advertised.

Further, if the remaining time is equal to or less than five hours, and the number of purchases of the article “A” until the subject time point is equal to or less than 100, it is considered that the article “A” does not sell well, and the article “A” is advertised. Moreover, if the remaining time is equal to or less than one hour, and the number of purchases of the article “A” until the subject time point is equal to or less than 200, it is considered that the article “A” does not sell well, and the article “A” is advertised.

Note that, the advertisement control illustrated in FIG. 6 is configured so as not to advertise the article “A” when the number of purchases of the article “A” is equal to or more than 201. In the article screen 40 illustrated in FIG. 4, the unit price of the article “A” is set to the minimum price (1,000 yen) when the number of purchases reaches 201. Therefore, the case where the number of purchases of the article “A” is equal to more than 201 is a case where the unit price of the article “A” reaches the minimum price. Thus, the advertisement control illustrated in FIG. 6 is set so as not to advertise the article “A” when the unit price of the article “A” reaches the minimum price. With this setting, the remaining number of an article is small, or an article has sold well, an advertisement is not carried out, which results in an effective advertisement.

A description is now given of a configuration for realizing the above-mentioned advertisement control.

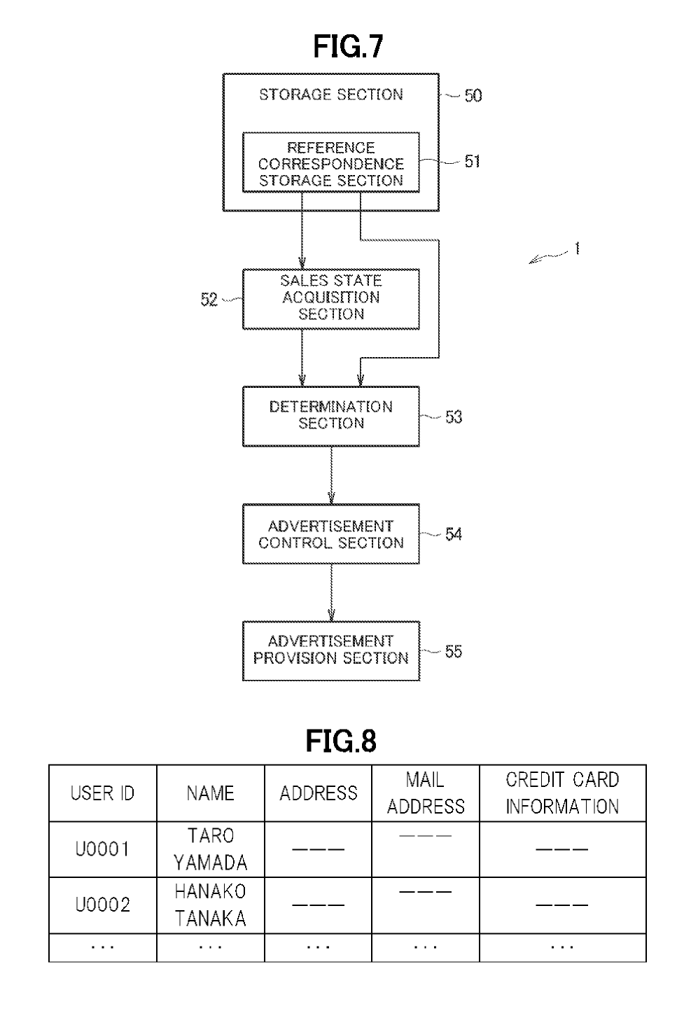

FIG. 7 is a functional block diagram illustrating functional blocks relating to the advertisement function out of functional blocks realized by the electronic commerce system 1. As illustrated in FIG. 7, the electronic commerce system 1 includes a storage section 50, a sales state acquisition section 52, a determination section 53, an advertisement control section 54, and an advertisement provision section 55.

For example, the storage section 50 is realized by the database 16, and the sales state acquisition section 52, the determination section 53, the advertisement control section 54, and the advertisement provision section 55 are realized in the server 10. In other words, in the case where the control unit 11 of the server 10 executes programs, the control unit 11 functions as the sales state acquisition section 52, the determination section 53, the advertisement control section 54, and the advertisement provision section 55.

First, a description is given of the storage section 50. The storage section 50 stores various types of data. FIGS. 8 to 14 illustrate examples of data stored in the storage section 50.

FIG. 8 illustrates an example of a user table. Information on users using the virtual shopping mall is registered to the user table. The user table illustrated in FIG. 8 includes “USER ID”, “NAME”, “ADDRESS”, “MAIL ADDRESS”, and “CREDIT CARD INFORMATION” fields.

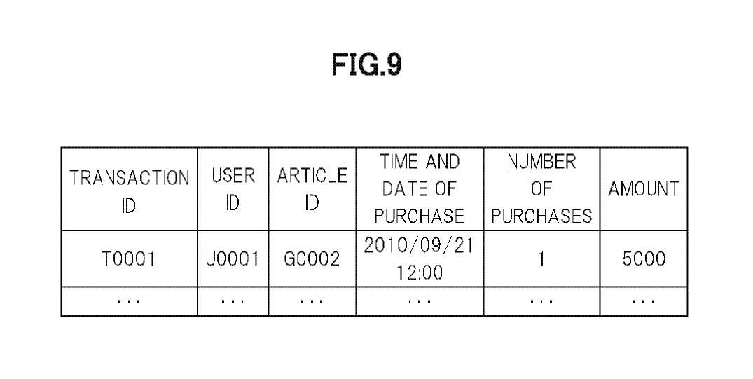

FIG. 9 illustrates an example of a purchase history table. Article purchase history of each of the users is registered to the purchase history table. The purchase history table illustrated in FIG. 9 includes “TRANSACTION ID”, “USER ID”, “ARTICLE ID”, “TIME AND DATE OF PURCHASE”, “NUMBER OF PURCHASES” and “AMOUNT” fields.

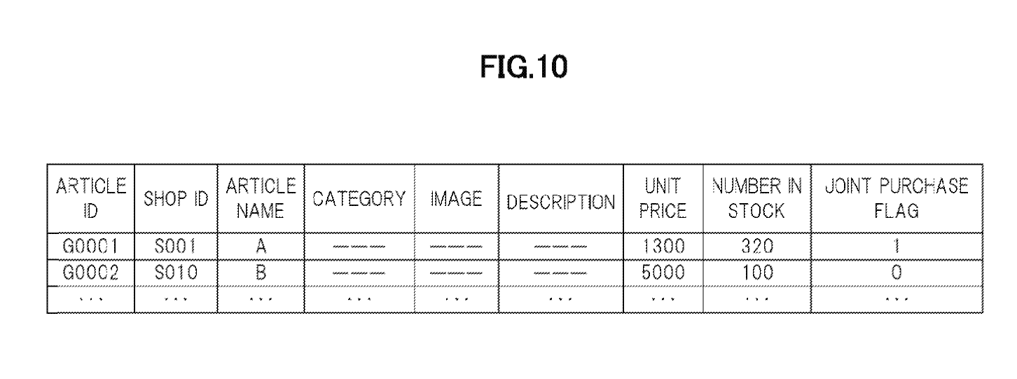

FIG. 10 illustrates an example of an article table. Information on articles which the virtual shopping mall deals in is registered to the article table. The article table illustrated in FIG. 10 includes “ARTICLE ID”, “SHOP ID”, “ARTICLE NAME”, “CATEGORY”, “IMAGE”, “DESCRIPTION”, “UNIT PRICE”, “NUMBER IN STOCK” and “JOINT PURCHASE FLAG” fields. The “SHOP ID” field represents a shop ID of a shop dealing in an article . The “IMAGE” field represents a file name, a stored location, or the like of image data of the article. The “UNIT PRICE” field represents an original price of the article.

The “JOINT PURCHASE FLAG” field represents whether or not the sales method of the joint purchase type is employed. For example, the “JOINT PURCHASE FLAG” field stores “0” or “1”. “0” represents that the sales method of the joint purchase type is not employed, and “1” represents that the sales method of the joint purchase type is employed.

Note that, an article having an article ID “G0001” is the article “A” displayed on the article screen 40 illustrated in FIG. 4.

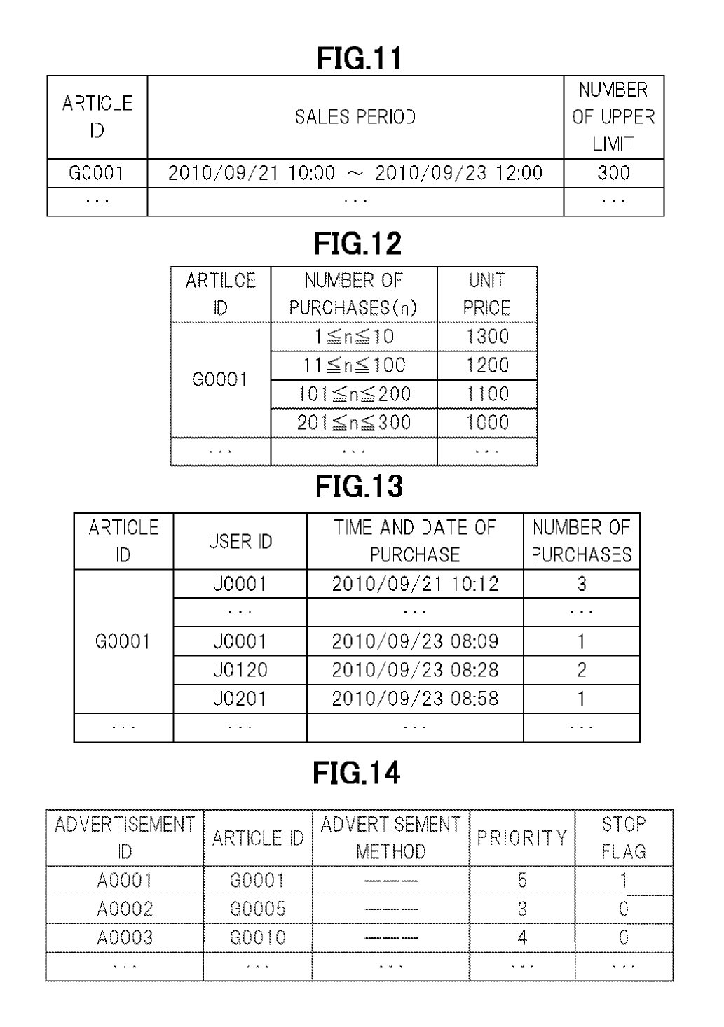

Data illustrated in FIGS. 11 to 13 is data to which information required for employing the sales method of the joint purchase type is registered. FIG. 11 illustrates an example of a joint purchase table. The joint purchase table illustrated in FIG. 11 includes “ARTICLE ID”, “SALES PERIOD”, and “UPPER LIMIT NUMBER” fields. The “UPPER LIMIT NUMBER” field represents the maximum number of articles which a shop can sell by means of the sales method of the joint purchase type.

FIG. 12 illustrates an example of a joint purchase price table. Information on prices for the case where the sales method of the joint purchase type is employed is registered to the joint purchase price table. The joint purchase price table illustrated in FIG. 12 includes “ARTICLE ID”, “NUMBER OF PURCHASES”, and “UNIT PRICE” fields, and represents relationships between the number of purchases of an article and unit prices. As the number of purchases of an article increases, the unit price of the article decreases.

FIG. 13 illustrates an example of a joint purchase state table. A purchase state at a current time point of an article for which the sales method of the joint purchase type is employed is registered to the joint purchase state table. The joint purchase state table illustrated in FIG. 13 includes “ARTICLE ID”, “USER ID”, “TIME AND DATE OF PURCHASE”, and “NUMBER OF PURCHASES” fields.

The above-mentioned data (FIGS. 8 to 13) is referred to when a search for an article is carried out, or the article list screen or the article screen 40 is generated. For example, the article screen 40 is generated based on the article table, the joint purchase table, the joint purchase price table, and the joint purchase state table.

FIG. 14 illustrates an example of an advertisement table. Information on an advertisement for an article which a shop wants to be advertised is registered to the advertisement table. The advertisement table illustrated in FIG. 14 includes “ADVERTISEMENT ID”, “ARTICLE ID”, “ADVERTISEMENT METHOD”, “PRIORITY”, and “STOP FLAG” fields. Information on a method of carrying out an advertisement is registered in the “ADVERTISEMENT METHOD” field.

The “PRIORITY” field represents a priority of an advertisement. For example, a numerical value of “1” to “5” is stored in the “PRIORITY” field, and the priority increases as the numerical value increases. An article having a higher priority tends to be advertised more. For example, the priority is set based on an advertisement fee paid by a shop.

The “STOP FLAG” field represents whether or not provision of an advertisement is stopped. For example, the “STOP FLAG” field stores “0” or “1”. “0” represents that the provision of an advertisement is not stopped, and “1” represents that the provision of the advertisement is stopped.

As illustrated in FIG. 7, the storage section 50 includes a reference correspondence storage section 51. The reference correspondence storage section 51 stores information on a reference correspondence predefined between a time point in a sales period and a sales state of an article.

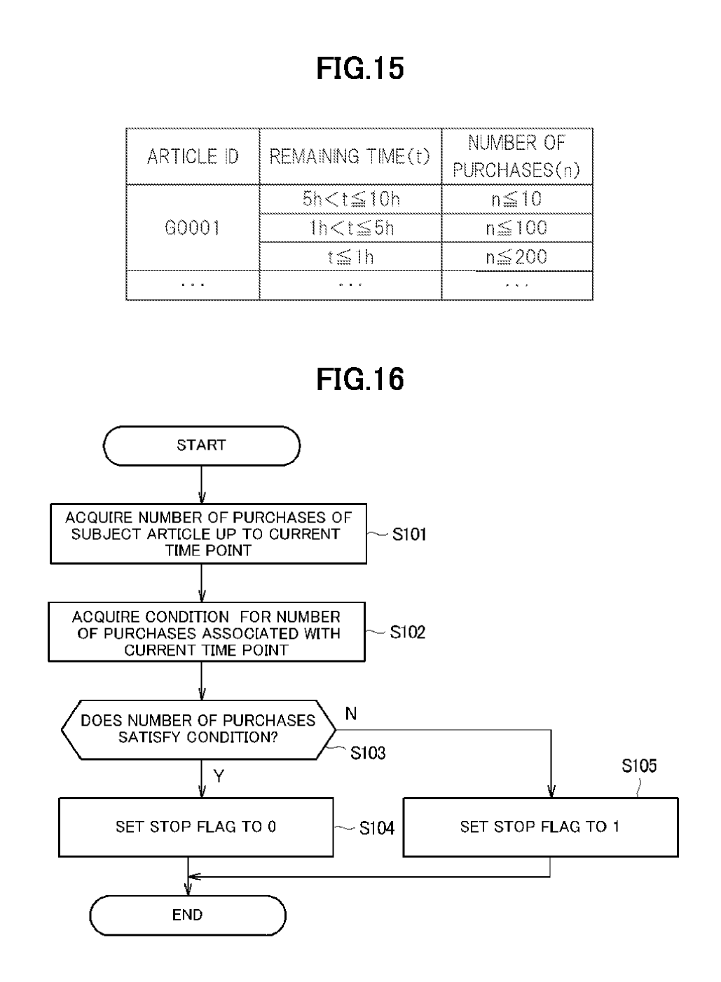

For example, the reference correspondence storage section 51 stores the information representing the reference correspondence in a table form. FIG. 15 illustrates an example of a reference correspondence table stored in the reference correspondence storage section 51. In the reference correspondence table illustrated in FIG. 15, the reference correspondence is retained for each article. In other words, for each article, a partial period in a sales period and a condition relating to the sales state are associated with each other.

Specifically, the reference correspondence table illustrated in FIG. 15 includes “ARTICLE ID”, “REMAINING TIME”, and “NUMBER OF PURCHASES” fields. The “REMAINING TIME” field represents a range of a remaining time. The remaining time is a remaining time until the sales period ends. The “NUMBER OF PURCHASES” field represents a condition relating to the number of purchases (number of sales) of an article.

A content of the reference correspondence table illustrated in FIG. 15 is a content for realizing the advertisement control described above referring to FIG. 6. In other words, the reference correspondence between the “REMAINING TIME” and the “NUMBER OF PURCHASES” defined in the reference correspondence table represents a state which can be considered that an article does not sell well.

By the way, in the reference correspondence table, an “ELAPSED TIME” field may be provided in place of the “REMAINING TIME” field. The “ELAPSED TIME” field is a field representing a condition relating to an elapsed time after a sales period starts.

Moreover, a “PERIOD” field may be provided in place of the “REMAINING TIME” field. The “PERIOD” field is a field for representing a partial period of the sales period by using actual times and dates such as “2010/09/23 11:00-2010/09/23 12:00”.

Moreover, in the reference correspondence table, a “REMAINING NUMBER” field may be provided in place of the “NUMBER OF PURCHASES” field. “REMAINING NUMBER” means the number of remaining salable articles (number in stock), and is a numerical value obtained by subtracting the number of purchases from the upper limit number of articles salable during the sales period. The “REMAINING NUMBER” field is a field representing a condition relating to the remaining number.

Moreover, a “CONSUMPTION RATE” field may be provided in place of the “NUMBER OF PURCHASES” field. The “CONSUMPTION RATE” is a numerical value obtained by dividing the number of purchases of an article by the upper limit number of salable articles in the sales period. The “CONSUMPTION RATE” field is a field representing a condition of the consumption rate.

Note that, the reference correspondence storage section 51 may store information on the reference correspondence represented in a numerical expression format. For example, the following expression (1) may be stored.

n<N*(e/T) (1)

In the above-mentioned expression (1), “e” denotes an elapsed time (unit: time) after a sales period starts, and “T” denotes a length (unit: time) of the sales period. “n” denotes a number of purchases, and “N” denotes an upper limit number of articles which a shop can sell. For example, for the article illustrated in FIGS. 4 and 11, “N” is “300”. Note that, the number of articles which a shop wants to sell until the end time point of a sales period may be set as “N”. For example, when a shop wants to sell 250 articles out of 300 articles until the end point of a sales period, “N” may be set to “250”.

The expression (1) represents a reference correspondence between the “elapsed time” and the “number of purchases”. Moreover, the reference correspondence represented by the expression (1) also represents a state which can be considered that the article does not sell well.

The above-mentioned reference correspondence may be set by a shop which requests an advertisement from the shop terminal 4, may be set by an administrator of the electronic commerce system 1 who receives an instruction from a shop, or may be automatically set by the electronic commerce system 1 (server 10).

A description is now given of the sales state acquisition section 52. The sales state acquisition section 52 acquires information on a sales state of an article at a certain time point during a sales period. The “certain time point” is, for example, a current time point. Note that, the “certain time point” may be, for example, a time point before the current time point.

The “information on a sales state” is information on, for example, the number of purchases (number of sales) of an article. For example, when the reference correspondence table illustrated in FIG. 15 is stored in the reference correspondence storage section 51, the sales state acquisition section 52 may acquire the number (n) of purchases of an article.

Note that, if the “REMAINING NUMBER” field is provided in place of the “NUMBER OF PURCHASES” field in the reference correspondence table, the sales state acquisition section 52 may acquire the remaining number of the articles. Moreover, if the “CONSUMPTION RATE” field is provided in place of the “NUMBER OF PURCHASES” field in the reference correspondence table, the sales state acquisition section 52 may acquire the consumption rate of the articles.

A description is now given of the determination section 53. When the sales state acquisition section 52 acquires the information on the sales state of an article up to a certain time point (hereinafter referred to as “time point X”) during a sales period, the determination section 53 determines whether or not the time point X and the sales state of the article at the time point X have a reference correspondence.

On this occasion, it is assumed that the reference correspondence table illustrated in FIG. 15 is stored in the reference correspondence storage section 51. As described above, in the reference correspondence table, a partial period in a sales period and a condition relating to the sales state are associated with each other.

In this case, the determination section 53 determines whether or not the sales state at the time point X satisfies a condition associated with a partial period to which the time point X belongs. When the sales state at the time point X satisfies the condition, the determination section 53 determines that the time point X and the sales state of the article at the time point X have the reference correspondence.

Specifically, the determination section 53 acquires a remaining time (t) from the time point X to the end time point of the sales period. Then, the determination section 53 determines whether or not the number (n) of purchases up to the time point X satisfies a condition associated with the remaining time (t). For example, when the remaining time (t) is “two hours”, the determination section 53 determines whether or not the number (n) of purchases up to the time point X satisfies “n100”. When the number (n) of purchases satisfies “n100”, the determination section 53 determines that the time point X and the sales state of the article at the time point X have the reference correspondence.

Note that, the determination section 53 may determine whether or not the time point X belongs to a partial period associated with a condition which the sales state at the time point X satisfies. Then, when the time point X belongs to the partial period, the determination section 53 determines that the time point X and the sales state of the article at the time point X have the reference correspondence.

Specifically, the determination section 53 may acquire a range of the remaining time (t) corresponding to the number (n) of purchases up to the time point X. Then, the determination section 53 may determine whether or not the remaining time (t) belongs to the range. For example, the number of purchases up to the time point X is “98”, the determination section 53 determines whether or not the remaining time (t) satisfies “1 h≦t≦5 h”. Then, when the remaining time (t) satisfies “1 h≦t≦5 h”, the determination section 53 determines that the time point X and the sales state of the article at the time point X have the reference correspondence.

On this occasion, a case where the expression (1) is stored in the reference correspondence storage section 51 is assumed. In this case, the determination section 53 determines whether or not the time point X and the sales state at the time point X satisfy the expression (1). In other words, the determination section 53 determines whether or not the elapsed time (e) from the start time point of the sales period to the time point X and the number (n) of purchases up to the time point X satisfy the expression (1). Then, when the expression (1) is satisfied, the determination section 53 determines that the time point X and the sales state of the article at the time point X have the reference correspondence.

A description is now given of the advertisement control section 54. The advertisement control section 54 controls the advertisement provision section 55 based on the determination result by the determination section 53.

For example, based on the determination result by the determination section 53, the advertisement control section 54 determines whether or not to provide an advertisement. More specifically, when the determination result by the determination section 53 is a predetermined result, the advertisement control section 54 determines to provide an advertisement. The “predetermined result” is, for example, such a determination result that the time point X and the sales state of the article at the time point X have the reference correspondence. On the other hand, when the determination result by the determination section 53 is not the predetermined result, the advertisement control section 54 determines not to provide an advertisement.

Moreover, when the unit price of an article subject to the joint purchase reaches the minimum unit price, the advertisement control section 54 restricts provision of an advertisement for the article.

For example, in the reference correspondence table illustrated in FIG. 15, there is such a setting that when the unit price of the article reaches the minimum unit price, an advertisement is not provided. Then, as a result, when the unit price of the article reaches the minimum unit price, the advertisement control section 54 determines not to provide an advertisement.

Note that, when the expression (1) is stored, the advertisement control section 54 determines whether or not the unit price of the article reaches the minimum unit price. Then, when the unit price of the article reaches the minimum unit price, even if the expression (1) is satisfied, the advertisement control section 54 determines not to provide an advertisement for the article.

A description is now given of the advertisement provision section 55. The advertisement provision section 55 provides an advertisement. In this embodiment, the advertisement provision section 55 provides an advertisement when the advertisement control section 54 determines to provide the advertisement.

Moreover, the advertisement provision section 55 (advertisement content setting means) sets a content of an advertisement based on the sales state of an article. Particularly, the advertisement provision section 55 includes at least one of the following contents in an advertisement for an article subject to the joint purchase.

(1) A content relating to a deficit number of purchases of an article for decreasing the unit price of the article
(2) A content relating to a degree of a decrease in unit price of an article
(3) A content relating to the end time point of the sales period

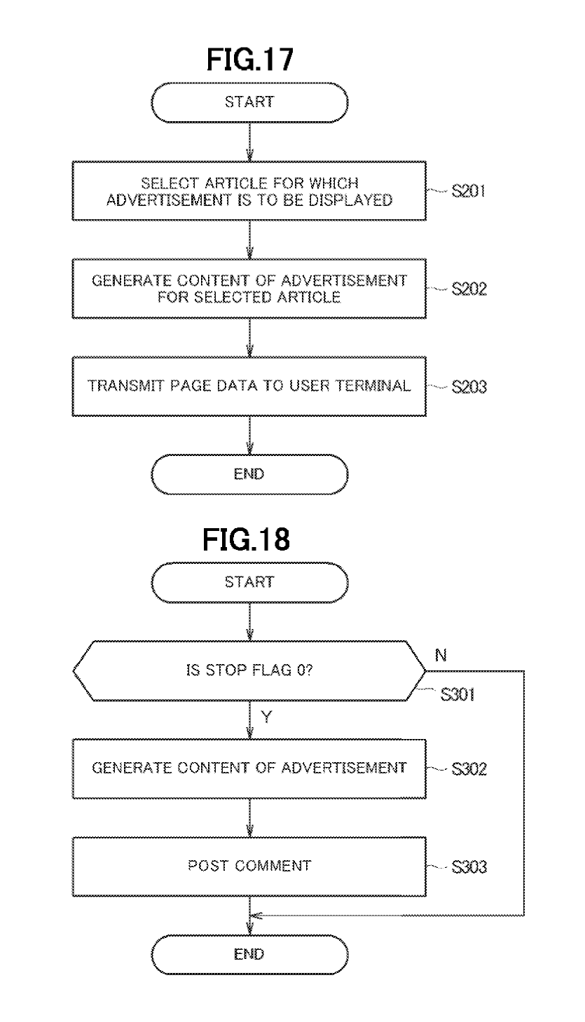

A description is now given of processing carried out by the electronic commerce system 1 (server 10) to realize the above-mentioned functional blocks. FIGS. 16 and 17 are flowcharts mainly illustrating processing relating to the advertisement function out of processing carried out by the server 10.

First, a description is given of processing illustrated in FIG. 16. In the server 10, processing of determining, for each of the articles registered to the advertisement table, whether or not to provide an advertisement based on the sales state is carried out. The processing illustrated in FIG. 16 is an example of processing of determining whether or not to provide an advertisement for an article subject to the joint purchase. The processing illustrated in FIG. 16 is carried out for each of the articles.

The processing illustrated in FIG. 16 is carried out at a predetermined time point. For example, the processing illustrated in FIG. 16 is carried out every predetermined time period (such as 30 minutes). Alternatively, the processing illustrated in FIG. 16 is carried out at a predetermined time.

In the advertisement control illustrated in FIG. 6, there is such setting that, until the remaining time until the sales period of an article ends is equal to or less than ten hours, an advertisement is not carried out. In this case, the stop flag (refer to FIG. 14) of the article maybe set to “1” in advance, and until the remaining time until the sales period of the article ends is equal to or less than ten hours, the processing illustrated in FIG. 16 may not be carried out. Then, when the remaining time is equal to or less than ten hours, the processing illustrated in FIG. 16 may be carried out, and then the processing illustrated in FIG. 16 may be carried out every predetermined time period (such as 30 minutes).

The control unit 11 of the server 10 carries out the processing illustrated in FIG. 16 in accordance with a program. By the control section 11 carrying out the processing illustrated in FIG. 16, the sales state acquisition section 52, the determination section 53, and the advertisement control section 54 are realized. Note that, an article subject to processing (namely, subject to the determination as to whether or not to provide an advertisement) is hereinafter referred to as “subject article”. Moreover, on this occasion, assuming that the reference correspondence table illustrated in FIG. 15 is stored, a description is given of the processing illustrated in FIG. 16.

As illustrated in FIG. 16, first the control section 11 (sales state acquisition section 52) acquires a number of purchases of a subject article up to the current time point (S101). The control section 11 carries out the processing in Step S101 based on the joint purchase state table (FIG. 13). For example, when the article ID of the subject article is “G0001”, the control section 11 acquires a sum of the values in the “NUMBER OF PURCHASES” fields of records having the article ID of “G0001”.

Moreover, the control section 11 (determination section 53) acquires a condition for the number of purchases associated with the current time point (S102). In Step S102, the control section 11 calculates the remaining time (t) from the current time point to the end time point of a sales period. Note that, the sales period of the subject article is acquired from the joint purchase table (refer to FIG. 11). Then, the control unit 11 acquires the condition for the number of purchases associated with the remaining time (t) from the reference correspondence table (FIG. 15). For example, when the remaining time is “2 HOURS”, the condition “n≦100” is acquired.

Then, the control unit 11 (determination section 53) determines whether or not the number of purchases acquired in Step S101 satisfies the condition acquired in Step S102 (S103).

When the control unit 11 determines that the number of purchases satisfies the condition, the control unit 11 (advertisement control section 54) sets the stop flag of the subject article to “0” (S104). In Step S104, the advertisement table (FIG. 14) is updated. For example, if the article ID of the subject article is “G0001”, the control unit 11 sets the values of the “STOP FLAG” fields of records having the article ID of “G0001” to “0”. In this case, the state where provision of the advertisement for the subject article can be carried out is brought about.

On the other hand, when the control unit 11 determines that the number of purchases does not satisfy the condition, the control unit 11 (advertisement control section 54) sets the stop flag of the subject article to “1” (S105). Also in Step S105, the advertisement table (FIG. 14) is updated. For example, if the article ID of the subject article is “G0001”, the control unit 11 sets the values of the “STOP FLAG” fields of records having the article ID of “G0001” to “1”. In this case, provision of the advertisement for the subject article is stopped.

Note that, processing described below may be carried out in place of processing in Steps S102 and S103 illustrated in FIG. 16.

In place of execution of the processing in Step S102, the control unit 11 may refer to the reference correspondence table (FIG. 15), determine conditions which the number of purchases acquired in Step S101 satisfies, and acquire ranges of the remaining time associated with the conditions. For example, if the number of purchases of the subject article up to the current time point is “98”, the control unit 11 acquires “1 h≦t≦5 h” and “t≦1 h” as ranges of the remaining time (t) associated with the condition which the number of purchases satisfies.

Then, in place of the execution of the processing in Step S103, the control unit 11 may determine whether or not the remaining time (t) from the current time point to the end time point of the sales period is included in the acquired ranges. For example, if “1 h<t≦5 h” and “t≦1 h” are acquired as ranges of the remaining time (t) associated with the condition which the number of purchases satisfies, the control unit 11 determines whether or not the remaining time (t) from the current time point to the end time point of the sales period satisfies at least one of “1 h<t≦5 h” and “t≦1 h”.

This configuration can provide the same result as that of the case where the processing in Steps S102 and S103 is carried out.

A description is now given of processing illustrated in FIG. 17. FIG. 17 illustrates processing carried out when page data for a screen carrying an advertisement for an article is transmitted to the user terminal 20. For example, when a request to access to the top screen 30 is made by the user terminal 20, the processing illustrated in FIG. 17 is carried out. The control unit 11 of the server 10 carries out the processing illustrated in FIG. 17 in accordance with a program. By the control unit 11 carrying out the processing illustrated in FIG. 17, the advertisement provision section 55 is realized.

As illustrated in FIG. 17, first, the control unit 11 selects an article for which an advertisement is to be displayed (S201). The control unit 11 carries out the processing in Step S201 based on the advertisement table (FIG. 14). In other words, the control section 11 selects any one of articles having the stop flag of “0”. For example, probability information is set to each of the articles having the stop flag of “0”, and any one of the articles having the stop flag of “0” is selected according to the probability information thereof. Note that, higher probability information may be set to an article having a higher priority, and the article having the higher priority may be thus morel likely to be selected.

Then, the control unit 11 generates an advertisement content for the article selected in Step S201 (S202). For example, the control section 11 generates the content for the advertisement 31 as illustrated in FIG. 3 or 5.

In other words, the control unit 11 acquires the name of the article selected in Step S201 from the article table (FIG. 10). Moreover, the control unit 11 acquires the sales period for the article selected in Step S201 from the joint purchase table (FIG. 11), and calculates a remaining time until the sales period ends. Further, the control unit 11 calculates a deficit number of purchases for further decreasing the unit price of the article selected in Step S201 by one level. Specifically, the control unit 11 acquires the number of purchases of the article up to the current time point from the purchase state table (FIG. 13). Then, based on the number of purchases up to the current time point and the joint purchase price table (FIG. 12), the control unit 11 calculates the deficit number of purchases for further decreasing the unit price of the article by one level. Moreover, the control unit 11 calculates a difference between the unit price if the unit price of the article selected in Step S201 further decreases by one level, and the original unit price. Then, based on the acquired or calculated information as described above, the control unit 11 generates an advertisement content for the article selected in Step S201.

Note that, for example, when data on advertisement contents for articles is stored in advance in the database 16, the control unit 11 may acquire the advertisement content for the article selected in Step S201 from the database 16.

After the advertisement content for the article selected in Step S201 is generated, the control unit 11 generates page data based on the advertisement content generated in Step S202, and transmits the page data to the user terminal 20 (S203). On the user terminal 20, based on the page data, a screen is displayed on the display unit. For example, the top screen 30 as illustrated in FIG. 3 is displayed. The advertisement for the article selected in Step S201 is displayed on the screen. This is the end of the processing illustrated in FIG. 17.

According to the above-mentioned advertisement function of the electronic commerce system 1, an advertisement for the article is carried out considering both a time point and the purchase state of an article at the time point. According to the above-mentioned advertisement function, an advertisement for the article can be efficiently carried out considering the purchase state of the article.

According to the electronic commerce system 1, an advertisement for the article is restrained when an article sells well. Hence, the electronic commerce system 1 has such an advantage that an advertisement low in necessity for a shop (advertiser) is thus not carried out. Moreover, according to the electronic commerce system 1, when the article does not sell well, an advertisement for the article is carried out, thereby promoting the sales of the article. Hence, it is expected that sales at the shop increase. In other words, the electronic commerce system 1 provides the shop with such an advantage that the sale increases. Moreover, a provider of the virtual shopping mall can obtain a commission depending on sales at a shop, and hence the electronic commerce system 1 provides the provider of the virtual shopping mall with such an advantage as an increase in the commission income from the shops. Further, the electronic commerce system 1 efficiently carries out an advertisement for an article, and it is thus expected that satisfaction of the shop increases. In other words, the electronic commerce system 1 can increase the satisfaction of the shop for the service of the provider of the virtual shopping mall (provider of the advertisement service). As a result, the electronic commerce system 1 provides the provider with such an advantage that the shop continues to use the service of the provider.

Note that, the present invention is not limited to the above-mentioned embodiment.

(A) In the above-mentioned embodiment, an advertisement for an article is displayed on the top screen 30, the article list screen, and the like. However, other means may be employed as the means for advertising an article.

For example, an advertisement for an article may be provided by using a communication service which making public a comment posted by a poster to the public. For example, a social networking service such as the Twitter (trademark) service and the Facebook (trademark) service may be used as the communication service.

In this case, the advertisement provision section 55 provides the advertisement for the article by posting an advertisement for an article as a comment to the communication service.

FIG. 18 is a flowchart illustrating an example of processing carried out by the electronic commerce system 1 (server 10) in order to realize the advertisement provision section 55 configured in this way.

The processing illustrated in FIG. 18 is carried out at a predetermined time point. For example, the processing illustrated in FIG. 18 is carried out every predetermined time period (such as two hours). Alternatively, the processing illustrated in FIG. 18 is carried out at a predetermined time instant. Moreover, the processing illustrated in FIG. 18 is carried out for each of articles registered to the advertisement table.

The control unit 11 carries out the processing illustrated in FIG. 18 in accordance with the program. Note that, the program for carrying out the processing illustrated in FIG. 18 is realized by, for example, a program called “Bot”.

In the processing illustrated in FIG. 18, first, the control unit 11 determines whether or not the stop flag for a subject article is “0” (S301). In Step S301, the advertisement table (FIG. 14) is referred to. For example, if the article ID of the subject article is “G0001”, the control unit 11 determines whether or not the value of the “STOP FLAG” field of a record having the article ID of “G0001” is “0”.

When the control unit 11 determines that the stop flag of the subject article is “0”, the control unit 11 generates an advertisement content for the subject article (S302). For example, the control section 11 generates the same advertisement content as the content of the advertisement 31 as illustrated in FIG. 3 or 5. This processing is the same as the processing in Step S202 of FIG. 17. Note that, the control unit 11 may include a uniform resource locator (URL) for displaying the article image 40 of the subject article in the advertisement content.

After the advertisement content for the subject advertisement is generated, the control unit 11 posts a comment including the advertisement content generated in Step S302 to the communication service (S303). In other words, the control unit 11 logs in to the communication service with an account for the virtual shopping mall, and posts the comment. In this case, the advertisement for the subject article is provided via the communication service.

On the other hand, when it is determined in Step S301 that the stop flag for the subject article is not “0”, the processing ends. In this case, the control unit 11 does not provide an advertisement for the subject article.

Note that, the advertisement provision section 55 may advertise an article by using other means. For example, the advertisement provision section 55 may advertise the article by means of an electronic mail.

(B) In the above-mentioned embodiment, the advertisement control section 54 determines whether or not an advertisement is provided based on the determination result by the determination section 53. However, the advertisement control section 54 may change the priority of an advertisement for an article based on the determination result by the determination section 53.

For example, when the determination result by the determination section 53 is a predetermined result (for example, such a determination result that a time point X and a sales state of an article at the time point X have a reference correspondence), the advertisement control section 54 may set the priority of the advertisement to a normal priority. On the other hand, when the determination result by the determination section 53 is not the predetermined result, the advertisement control section 54 may decrease the priority of the advertisement from a normal priority.

For example, in the processing illustrated in FIG. 16, the stop flag of a subject article is set based on the determination result in Step S103. However, the priority of the subject article may be set based on the determination result in Step S103. For example, in Step S105, the control unit 11 may set the priority of the subject article to a priority lower than a normal priority of the article. On the other hand, in Step S104, the control unit 11 may set the priority of the subject article to a normal priority of the article.

In this way, for example, when an article sells well, an advertisement is carried out less frequently, and a configuration for less frequently providing an advertisement lower in necessity can be provided.

(C) Moreover, the advertisement control section 54 may change an advertisement method for an article based on the determination result by the determination section 53.

On this occasion, “changing the advertisement method for an article” is, for example, changing means used for the advertisement. For example, when the determination result by the determination section 53 is a predetermined result (for example, such a determination result that a time point X and a sales state of an article at the time point X have a reference correspondence), the advertisement control section 54 may cause the advertisement provision section 55 to provide an advertisement via a communication service. On the other hand, when the determination result by the determination section 53 is not the predetermined result, the advertisement control section 54 may cause the advertisement provision section 55 to provide an advertisement on the top screen 30 and the like.

Moreover, “changing the advertisement method for an article” is, for example, changing a form of the advertisement. For example, when the determination result by the determination section 53 is a predetermined result (for example, such a determination result that a time point X and a sales state of an article at the time point X have a reference correspondence), the advertisement control section 54 may cause the advertisement provision section 55 to provide an advertisement including texts and images. On the other hand, when the determination result by the determination section 53 is not the predetermined result, the advertisement control section 54 may cause the advertisement provision section 55 to provide an advertisement including only texts without images.

Further, “changing the advertisement method for an article” maybe, for example, changing a size of an advertisement, or a display location of an advertisement.

With the configurations described above, the advertisement method can be changed depending on the sales state of an article.

In other words, an optimal advertisement method can be employed depending on the sales state of an article.

(D) The reference correspondence storage means 51 may store advertisement control information on control of the provision of an advertisement associated with a reference correspondence. This configuration can finely change a content of the advertisement control relating to the article depending on the sales state of an article.

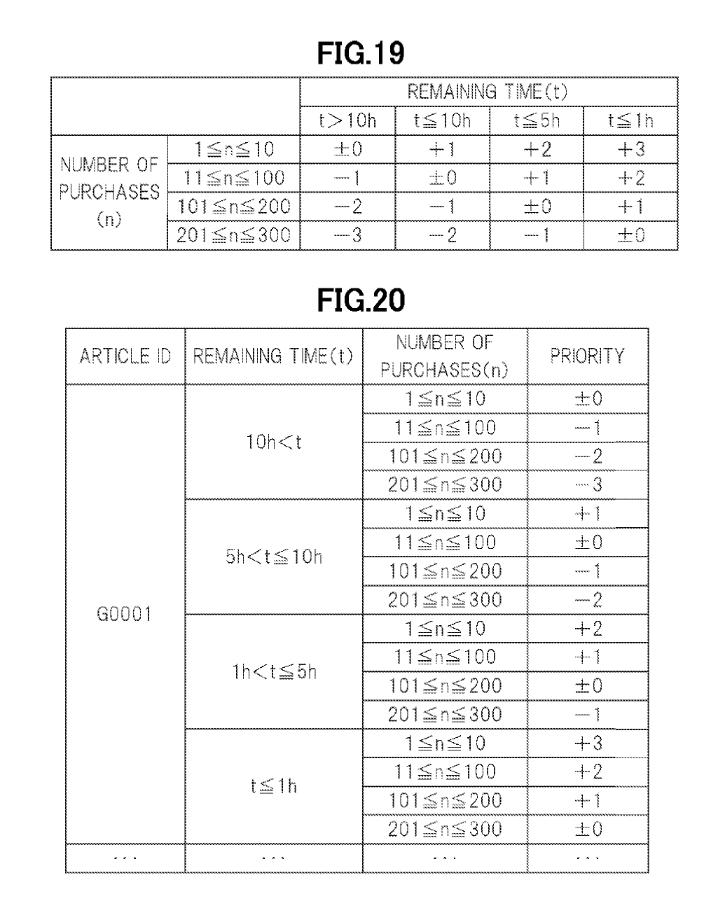

On this occasion, a case where advertisement control as illustrated in FIG. 19 is carried out is assumed. In FIG. 19, “−i” represents that the priority for an advertisement is set to a priority which is lower by i levels than a normal priority. “+i” represents that the priority is set to a priority which is higher by i levels than a normal priority. Moreover, “±0” represents that the priority is set to a normal priority.

According to the advertisement control illustrated in FIG. 19, the priority of an advertisement for the article is finely changed depending on the sales state of an article. In other words, as an article sells better, the priority of an advertisement for the article decreases, and as an article sells worse, the priority of the advertisement for the article increases.

FIG. 20 illustrates an example of the reference correspondence table for a case where the advertisement control as illustrated in FIG. 19 is carried out. The reference correspondence table illustrated in FIG. 20 includes “ARTICLE ID”, “REMAINING TIME”, “NUMBER OF PURCHASES”, and “PRIORITY” fields. Note that, “PRIORITY” field represents whether the priority of an advertisement for an article is increased or decreased, and the level of the increase/decrease. In this case, the “PRIORITY” field corresponds to the above-mentioned “advertisement control information”.

When the result of determining whether or not a time point X and a sales state of an article at the time point X have a reference correspondence is a predetermined result (such a determination result that the time point X and the sales state of the article at the time point X have the reference correspondence), the advertisement control section 54 in this aspect controls the provision of an advertisement based on advertisement control information associated with the reference correspondence. For example, a case where the remaining time until the sales period of the article having the article ID of “G0001” ends and the number of purchases thereof are respectively “FOUR HOURS” and “98” is assumed. In this case, the advertisement control section 54 increases the priority of an advertisement for the article by one level from the normal priority based on the reference correspondence table illustrated in FIG. 20.

This configuration enables finely changing the priority of an advertisement for the article depending on the sales state of an article.

Note that, the reference correspondence table illustrated in FIG. 20 may include an “ADVERTISEMENT METHOD” field representing an advertisement method, in place of the “PRIORITY” field. This configuration enables finely changing an advertisement method for the article depending on the sales state of an article.

(E) The server for carrying out the advertisement control may be a server independent of the server for carrying out the electronic commerce.

Moreover, the sales state acquisition section 52, the determination section 53, the advertisement control section 54, and the advertisement provision section 55 may not be realized on the same server. For example, the sales state acquisition section 52, the determination section 53, and the advertisement control section 54 may be realized on a server independent of a server for realizing the advertisement provision section 55.

(F) The present invention can be applied to a case where an article sold by employing a normal sales method is advertised, in addition to the case where an article subject to the joint purchase is advertised.

For example, when a shop which has 300 articles in stock sells the articles on the virtual shopping mall, the same advertisement control as the advertisement control described above referring to FIG. 6 may be carried out. In this case, a remaining time until a reference time point may be used as the “REMAINING TIME” of FIG. 6. In this case, the “reference time point” may be arbitrarily set by a shop. For example, when a shop wants to sell the entire articles until a certain time and date, the time and date may be set as the “reference time point”.

The advertisement control for an article sold by employing a normal sales method may be carried out in accordance with the above-mentioned expression (1). In this case, an elapsed time from the reference time point may be used as the “elapsed time (e)” in the expression (1). In this case, the “reference time point” is, for example, a sales start time point of the article. The “reference time point” may be arbitrarily set by a shop.

(G) The electronic commerce system 1 may sell, as an article, data such as electronic book data, music data, and video data in addition to goods such as clothes and foods (or in place of goods such as clothes and foods). In other words, the present invention can be applied to a case where an advertisement for data is carried out.

Moreover, the electronic commerce system 1 may sell services in addition to the articles (or in place of the articles). For example, a coupon used for receiving a service at a restaurant, an accommodation facility, and the like may be sold in the electronic commerce system 1. Moreover, when the service (coupon) is sold, the sales method of the joint purchase type may be employed. Moreover, the service may be advertised in the same manner as in the case where the article is advertised.

1. An advertisement system for providing an advertisement for an article or a service during a sales period of the article or the service, the advertisement system comprising:
reference correspondence storage means for storing information on a reference correspondence between a time point in the sales period and a sales state of the article or the service;
sales state acquisition means for acquiring information on the sales state of the article or the service at a certain time point in the sales period;
determination means for determining whether or not the certain time point and the sales state of the article or the service at the certain time point have the reference correspondence; and
advertisement provision means for providing the advertisement based on a determination result by the determination means.

2. The advertisement system according to claim 1, further comprising means for determining whether or not to provide the advertisement, based on the determination result by the determination means,
wherein the advertisement provision means provides the advertisement in a case where it is determined that the advertisement is provided.

3. The advertisement system according to claim 1, wherein:
the sales state of the article or the service comprises at least one of a number of purchases of the article or the service and a remaining number of the articles or the services which are salable; and
the sales state acquisition means acquires information on at least one of the number of purchases of the article or the service up to the certain time point and the remaining number of the articles or the services which are salable at the certain time point.

4. The advertisement system according to claim 1, wherein:
the sales state acquisition means acquires, at a predetermined time point, the information on the sales state of the article or the service at the predetermined time point; and
the determination means determines whether or not the predetermined time point and the sales state of the article or the service at the predetermined time point have the reference correspondence.

5. The advertisement system according to claim 1, wherein:
the article or the service is sold by a sales method of decreasing a unit price of the article or the service sold during the sales period depending on an increase in a number of sales of the article or the service during the sales period; and
the advertisement system further comprises means for restricting the provision of the advertisement in a case where the unit price of the article or the service decreases down to a predetermined minimum unit price.

6. The advertisement system according to claim 1, wherein:
the article or the service is sold by a sales method of decreasing a unit price of the article or the service sold during the sales period depending on an increase in a number of sales of the article or the service during the sales period;
the advertisement provision means includes advertisement content setting means for setting a content of the advertisement, based on the sales state of the article or the service; and
the advertisement content setting means includes, in the content of the advertisement, at least one of:
a content relating to a deficit number of sales of the article or the service for decreasing the unit price of the article or the service;
a content relating to a degree of decrease in unit price of the article or the service; and
a content relating to an end time point of the sales period.

7. The advertisement system according to claim 1, wherein the advertisement provision means provides the advertisement by posting a comment in a communication service for receiving a post of the comment and making public the comment.

8. The advertisement system according to claim 1, wherein the advertisement provision means includes means for changing a method of providing the advertisement, based on the determination result by the determination means.

9. The advertisement system according to claim 1, further comprising:
means for storing information on a priority of the advertisement; and
means for setting the priority of the advertisement based on the determination result by the determination means,
wherein the advertisement provision means provides the advertisement based on the priority of the advertisement.

10. The advertisement system according to claim 1, wherein:
the reference correspondence storage means stores advertisement control information on control of the provision of the advertisement associated with the reference correspondence; and
in a case where the determination result as to whether or not the certain time point and the sales state of the article or the service at the certain time point have the reference correspondence is a predetermined result, the advertisement provision means provides the advertisement based on the advertisement control information associated with the reference correspondence.

11. A method of controlling an advertisement system for providing an advertisement for an article or a service during a sales period of the article or the service, the method comprising:
a step of acquiring a reference correspondence, based on information on the reference correspondence between a time point in the sales period and a sales state of the article or the service, which is stored in reference correspondence storage means for storing the information;
a sales state acquisition step of acquiring information on the sales state of the article or the service at a certain time point in the sales period;
a determination step of determining whether or not the certain time point and the sales state of the article or the service at the certain time point have the reference correspondence; and
an advertisement control step of controlling provision of the advertisement based on a determination result in the determination step.

12. An advertisement control device for controlling provision of an advertisement for an article or a service during a sales period of the article or the service, the advertisement control device comprising:
means for acquiring a reference correspondence, based on information on the reference correspondence between a time point in the sales period and a sales state of the article or the service, which is stored in reference correspondence storage means for storing the information;
sales state acquisition means for acquiring information on the sales state of the article or the service at a certain time point in the sales period;
determination means for determining whether or not the certain time point and the sales state of the article or the service at the certain time point have the reference correspondence; and
advertisement control means for controlling the provision of the advertisement based on a determination result by the determination means.

13. A program for causing a computer to function as an advertisement control device for controlling provision of an advertisement for an article or a service during a sales period of the article or the service, the program further causing the computer to function as:
means for acquiring a reference correspondence, based on information on the reference correspondence between a time point in the sales period and a sales state of the article or the service, which is stored in reference correspondence storage means for storing the information;
sales state acquisition means for acquiring information on the sales state of the article or the service at a certain time point in the sales period;
determination means for determining whether or not the certain time point and the sales state of the article or the service at the certain time point have the reference correspondence; and
advertisement control means for controlling the provision of the advertisement based on a determination result by the determination means.

14. A computer-readable information storage medium having recorded thereon a program for causing a computer to function as an advertisement control device for controlling provision of an advertisement for an article or a service during a sales period of the article or the service, the program further causing the computer to function as:
means for acquiring a reference correspondence, based on information on the reference correspondence between a time point in the sales period and a sales state of the article or the service, which is stored in reference correspondence storage means for storing the information;
sales state acquisition means for acquiring information on the sales state of the article or the service at a certain time point in the sales period;
determination means for determining whether or not the certain time point and the sales state of the article or the service at the certain time point have the reference correspondence; and
advertisement control means for controlling the provision of the advertisement based on a determination result by the determination means.
